(19) United States
(12) Patent Application Publication
(10) Pub. No.: US 2014/0167705 A1
(43) Pub. Date: Jun. 19, 2014

(54) METHOD OF CHARGING BATTERY

(71) Applicant: DYNAPACK INTERNATIONAL TECHNOLOGY CORPORATION, Taoyuan (TW)

(72) Inventors: Ying-Yin CHANG, Taoyuan (TW); Chung-Hsing CHANG, Taoyuan (TW); Jiun-Ming CHEN, Taoyuan (TW); Yun-Chih LIN, Taoyuan (TW); Kun-Sheng SHEN, Taoyuan (TW); Wen-Yi CHEN, Taoyuan (TW)

(73) Assignee: Dynapack International Technology Corporation, Taoyuan (TW)

(21) Appl. No.: 13/720,634

(22) Filed: Dec. 19, 2012

(51) Int. Cl. H02J 7/00

(52) U.S. Cl. CPC H02J 7/007
USPC 320/157; 320/162

(57) ABSTRACT

A method of charging a battery includes following steps: First, a charging voltage is provided to charge the battery. Afterward, a charging control variable is judged whether to reach to an adjustment value. Afterward, the charging voltage is adjusted with a first voltage difference to continuously charge the battery when the charging control variable reaches to the adjustment value. Afterward, a health state value of the battery is judged whether less than or equal to a critical health state value. Finally, the charging voltage is increased with a second voltage difference to continuously charge the battery when the health state value of the battery is less than or equal to the critical health state value.

### BACKGROUND

1. Technical Field

The present disclosure relates generally to a method of charging a battery, and more particularly to a method of charging a Li-ion battery.

2. Description of Related Art

Reference is made to FIG. 1 which is a schematic view of a related art constant voltage charging scheme. As shown in FIG. 1, the abscissa represents the cycle count value and the ordinate represents the state of health (SOH) of the battery. Also, a battery life curve Chv with a higher charging voltage and a battery life curve Clv with a lower charging voltage are also shown in FIG. 1. That is, the battery life curve Chv indicates that the battery is charged under a higher constant voltage and the battery life curve Clv indicates that the battery is charged under a lower constant voltage. However, the conventional charging method using the constant voltage has disadvantage as follows. When the higher constant charging voltage is provided to charge the battery, the life of the battery will be reduced because of the sustained higher voltage of charging the battery. On the other hand, when the lower constant charging voltage is provided to charge the battery, the performance of the battery will be reduced.

For consumers, not only the capacity requirement of the battery is considered, but also the use life and stability of the battery are significant. Accordingly, it is desirable to provide a method of charging a battery to implement more flexible and reliable charging strategies and effectively slow down decline speed, improve performance, extend life of the battery. Especially, the consumers can actively select whether to use the charging strategies by themselves.

### SUMMARY

An object of the present disclosure is to provide a method of charging a battery to solve the above-mentioned problems. Accordingly, the method includes following steps: (a) a charging voltage is provided to charge the battery; (b) a charging control variable is judged whether to reach to an adjustment value; (c) the charging voltage is adjusted with a first voltage difference to continuously charge the battery when the charging control variable reaches to the adjustment value; (d) a health state value of the battery is judged whether less than or equal to a critical health state value; and (e) the charging voltage is increased with a second voltage difference to continuously charge the battery when the health state value of the battery is less than or equal to the critical health state value.

It is to be understood that both the foregoing general description and the following detailed description are exemplary, and are intended to provide further explanation of the present disclosure as claimed. Other advantages and features of the present disclosure will be apparent from the following description, drawings and claims.

### BRIEF DESCRIPTION OF DRAWINGS

The features of the present disclosure believed to be novel are set forth with particularity in the appended claims. The present disclosure itself, however, may be best understood by reference to the following detailed description of the present disclosure, which describes an exemplary embodiment of the present disclosure, taken in conjunction with the accompanying drawings, in which:

FIG. 1 is a schematic view of a related art constant voltage charging scheme;

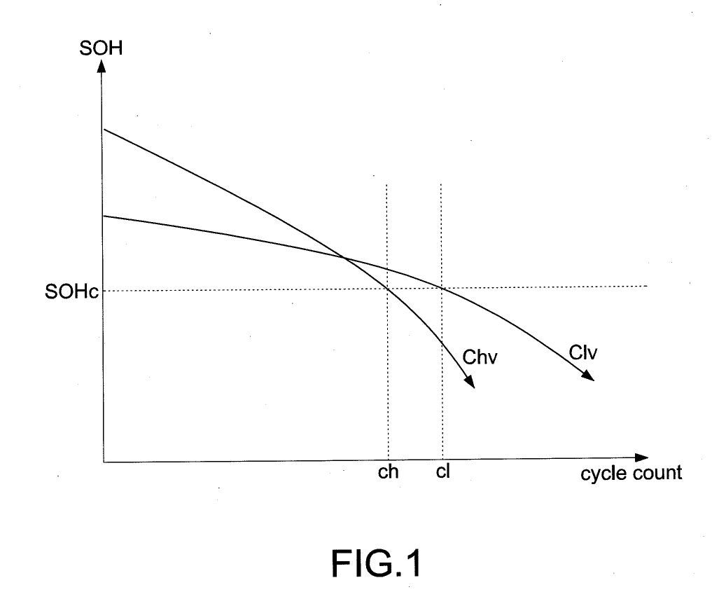

FIG. 2 is a flowchart of a method of charging a battery according the present disclosure;

FIG. 3 is a flowchart of the method according to a first embodiment of the present disclosure;

FIG. 4 is a flowchart of the method according to a second embodiment of the present disclosure;

FIG. 5 is a flowchart of the method according to a third embodiment of the present disclosure;

FIG. 6 is a flowchart of the method according to a fourth embodiment of the present disclosure;

FIG. 7 is a flowchart of the method according to a fifth embodiment of the present disclosure;

FIG. 8 is a flowchart of the method according to a sixth embodiment of the present disclosure;

FIG. 9A is a flowchart of the method of combining all charging control variables according to the present disclosure (first part);

FIG. 9B is a flowchart of the method of combining all charging control variables according to the present disclosure (second part); and

FIG. 10 is a schematic view of the method of adjusting the charging voltage according to the present disclosure.

### DETAILED DESCRIPTION

Reference will now be made to the drawing figures to describe the present disclosure in detail.

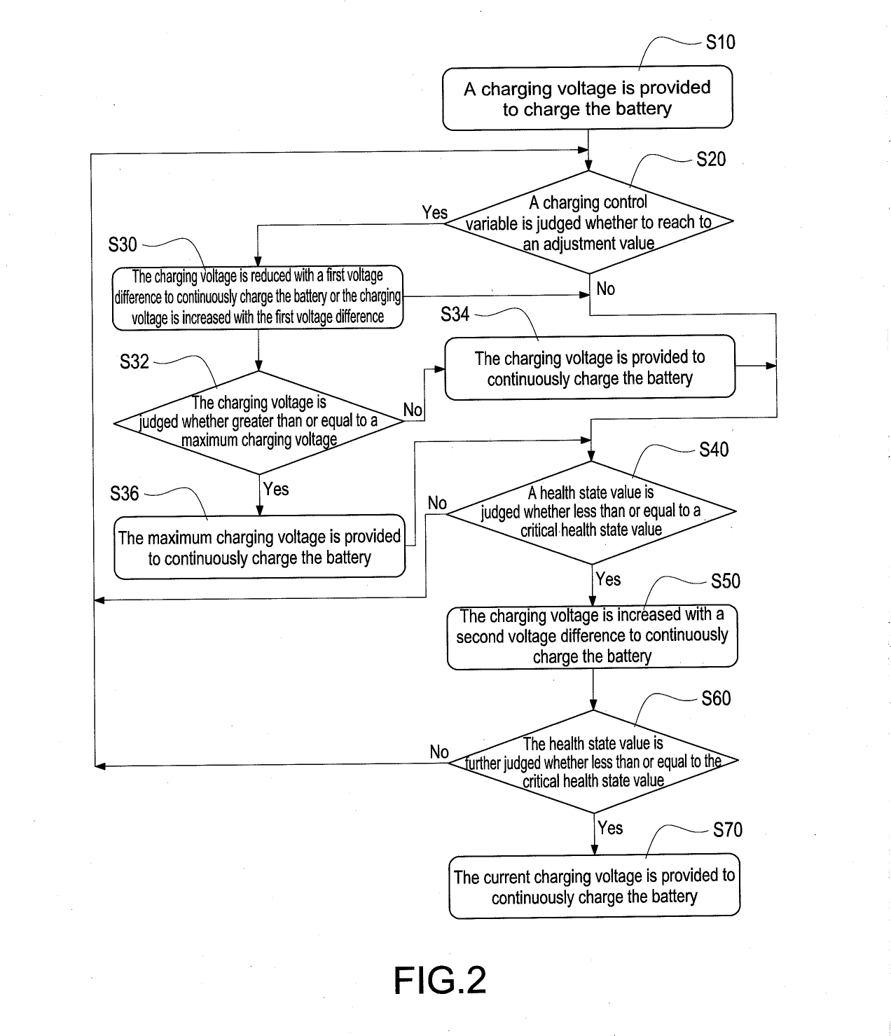

Reference is made to FIG. 2 which is a flowchart of a method of charging a battery according the present disclosure. The method includes following steps: first, a charging voltage is provided to charge the battery (S10). In particular, the battery can be a Li-ion battery. Also, the charging voltage can be the maximum charging voltage of the battery, but not limited. Afterward, a charging control variable is judged whether to reach to an adjustment value (S20). Especially, the charging control variable can be a cycle count value, a use time count value, an available capacity value, a DC resistance increment value, a charging environmental temperature value, or a charging rate value. In particular, the cycle count value means the charging and discharging cycle of the battery, the use time count value means the used time of the battery, the available capacity value means the remaining available capacity of the battery, the DC resistance increment value means the variation degree of the internal DC resistance during use of the battery, the charging environmental temperature value means the ambient temperature during charge of the battery, and the charging rate value means the rate of charging the battery, respectively. In addition, the adjustment value can be a cycle count adjustment value, a use time adjustment value, an available capacity adjustment value, a DC resistance increment adjustment value, an abnormal environmental temperature range value, or an abnormal charging rate range value correspondingly to the above-mentioned charging control variables. Afterward, the charging voltage is reduced with a first voltage difference to continuously charge the battery- or the charging voltage is increased with the first voltage difference when the charging control variable reaches to the adjustment value (S30). That is, when the charging control variable reaches to the adjustment value, the charging voltage can be reduced or increased to charge the battery. Afterward, the charging voltage is judged whether greater than or equal to a maximum charging voltage (S32) when the charging voltage is increased with the first voltage difference in the step (S30). The charging voltage is provided to continuously charge the battery when the charging voltage is less than the maximum charging voltage (S34), whereas the maximum charging voltage is provided to continuously charge the battery when the charging voltage is greater than or equal to the maximum charging voltage (S36). As mentioned above, when the cycle count value reaches to the cycle count adjustment value, the use time count value reaches to the use time adjustment value, the available capacity value reaches to the available capacity adjustment value, the DC resistance increment value reaches to the DC resistance increment adjustment value, the charging environmental temperature value reaches to the abnormal environmental temperature range value, or the charging rate value reaches to the abnormal charging rate range value, the charging voltage is adjusted with the first voltage difference to continuously charge the battery. The detailed operations of the charging control variables will be described hereinafter as follows. Afterward, a health state value of the battery is judged whether less than or equal to a critical health state value (S40). In particular, the critical health state value is set according to demands for battery products by manufacturers, such as 80%, but not limited. When the health state value of the battery is less than or equal to the critical health state value, the charging voltage is increased with a second voltage difference to continuously charge the battery (S50). Especially, the health state value of the battery is a target of judging whether the charging voltage is increased or not, that is, when the health state value of the battery declines below the product demand, the charging voltage is increased to improve performance and extend life of the battery. In particular, the second voltage difference can be the same with the first voltage difference, such as 0.1 volts, but not limited.

After the step (S20), the step (S40) is executed when the charging control variable does not reach the adjustment value. That is, once the charging control variable has not achieved to the corresponding adjustment value, the charging voltage does not need to be adjusted and then the health state value of the battery is judged. After the step (S40), the step (S20) is executed when the health state value of the battery is greater than the critical health state value. That is, when the health state value of the battery is greater than the critical health state value, it means that the healthy state of the battery meets product demands. Hence, the charging control variable is judged again. After the step (S50), the health state value of the battery is further judged whether less than or equal to the critical health state value (S60). That is, after the charging voltage is increased to improve performance control of the battery, if the health state value of the battery is less than or equal to the critical health state value, the current charging voltage is provided to continuously charge the battery (S70). That is, if the health state value of the battery still declines below the product demand after increasing the charging voltage, the charging voltage no longer has to be controlled according to these charging control variables. On the contrary, when the health state value of the battery is greater than the critical health state value, the step (S20) is executed. That is, when the health state value of the battery is greater than the critical health state value, it means that the healthy state of the battery meets product demands.

As mentioned above, the charging control variable can be the cycle count value, the use time count value, the available capacity value, the DC resistance increment value, the charging environmental temperature value, or the charging rate value. Hence, the detailed operations of the six charging control variables will be described hereinafter as follows.

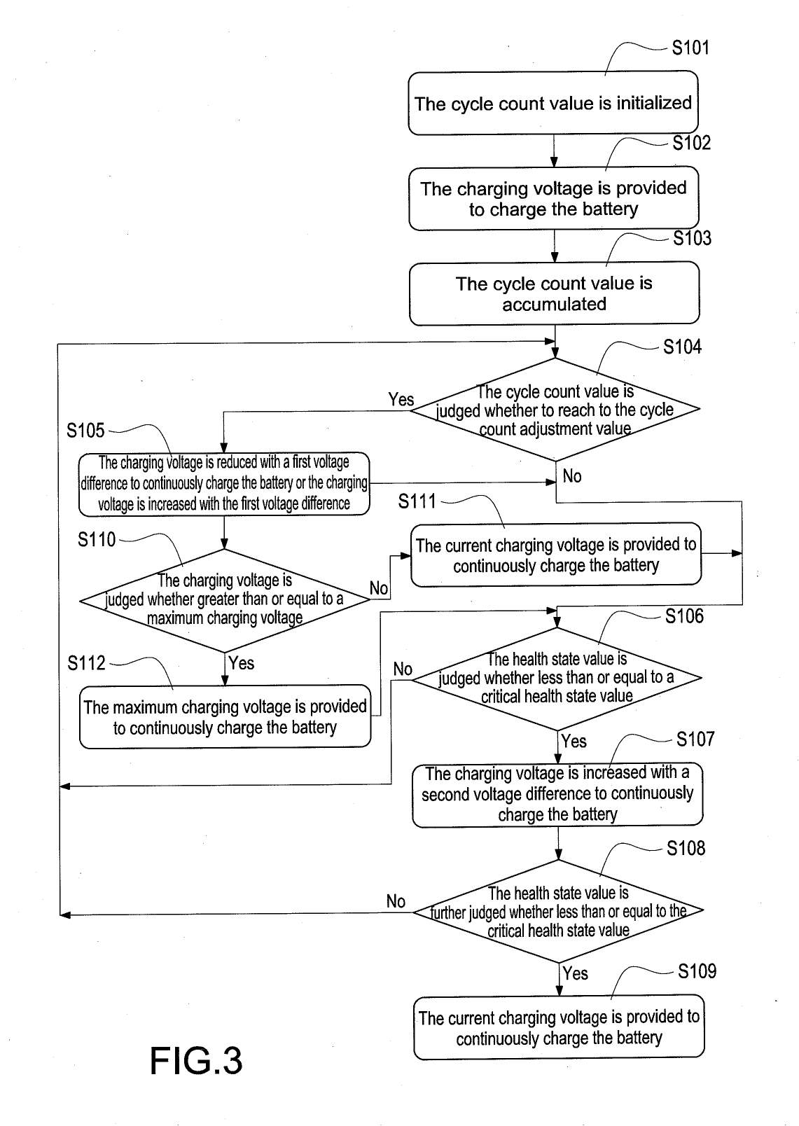

Reference is made to FIG. 3 which is a flowchart of the method according to a first embodiment of the present disclosure. In this embodiment, the cycle count value is exemplified for further demonstration. First, the cycle count value is initialized (S101). Because the cycle count value is used to record the number of times of charging and discharging the battery, the cycle count value has to be initialized to zero. Afterward, the charging voltage is provided to charge the battery (S102), that is, the charging process is executed. It is assumed that the charging voltage of the battery is 4.2 volts. During the use of the battery, the cycle count value of the battery is accumulated (S103). Afterward, the cycle count value is judged whether to reach to the cycle count adjustment value (S104). In this embodiment, the charging voltage is adjusted when the cycle count value of the battery reaches to the cycle count adjustment value (it is assumed that the cycle count adjustment value is equal to multiples of 100), thus slowing down decline speed and extending life of the battery. Hence, the step (S104) is that the cycle count value is judged whether to reach to multiples of 100. When the cycle count value reaches to the cycle count adjustment value, the charging voltage is reduced with the first voltage difference to continuously charge the battery or the charging voltage is increased with the first voltage difference (S105). Take reducing the charging voltage as the example, it is assumed that the first voltage different is 0.1 volts. That is, the charging voltage is reduced from 4.2 to 4.1 volts when the cycle count value reaches to 100, thus slowing down decline speed and extending life of the battery. In addition, in the step (S105), the upper limit of the charging voltage must be limited if the charging voltage is increased for charging the battery. That is, after the step (S105), the charging voltage is judged whether greater than or equal to a maximum charging voltage of the battery (S110). The current charging voltage is provided to continuously charge the battery (S111) when the charging voltage is less than the maximum charging voltage, whereas the maximum charging voltage is provided to continuously charge the battery when the charging voltage is greater than or equal to the maximum charging voltage (S112). Especially, the charging voltage is not limited to be adjusted in only way of reducing or increasing. That is, the charging voltage can be alternatively adjusted between reducing and increasing thereof. On the contrary, in the step (S104), the health state value of the battery is judged whether less than or equal to a critical health state value (S106) when the cycle count value does not reach to the cycle count adjustment value. That is, the current charging voltage is provided to continuously charge the battery when the cycle count value does not accumulated to multiples of 100. It is assumed that the critical health state value is set to 80%. Hence, in the step (S106), if the health state value of the battery is greater than 80%, it means that the healthy state of the battery meets product demands so that the step (S103) is executed again. On the contrary, in the step (S106), if the health state value of the battery is less than or equal to 80%, it means that the battery declines below the product demand. Hence, the charging voltage is increased with a second voltage difference to continuously charge the battery (S107). It is assumed that the second voltage difference is 0.1 volts. That is, if the health state value of the battery is less than or equal to 80%, the charging voltage is increased from 4.1 to 4.2 to charge the battery, thus improving performance and extending life of the battery. Afterward, the health state value of the battery is further judged whether less than or equal to the critical health state value (S108). If the health state value of the battery is less than or equal to 80%, the current charging voltage is provided to charge the battery (S109). That is, if the health state value of the battery still declines below the product demand after increasing the charging voltage, the charging voltage no longer has to be controlled according to these charging control variables. On the contrary, if the health state value of the battery is still greater than the critical health state value, the step (S103) is executed. That is, when the health state value of the battery is greater than 80%, it means that the healthy state of the battery still meets product demands so that the step (S103) is executed again.

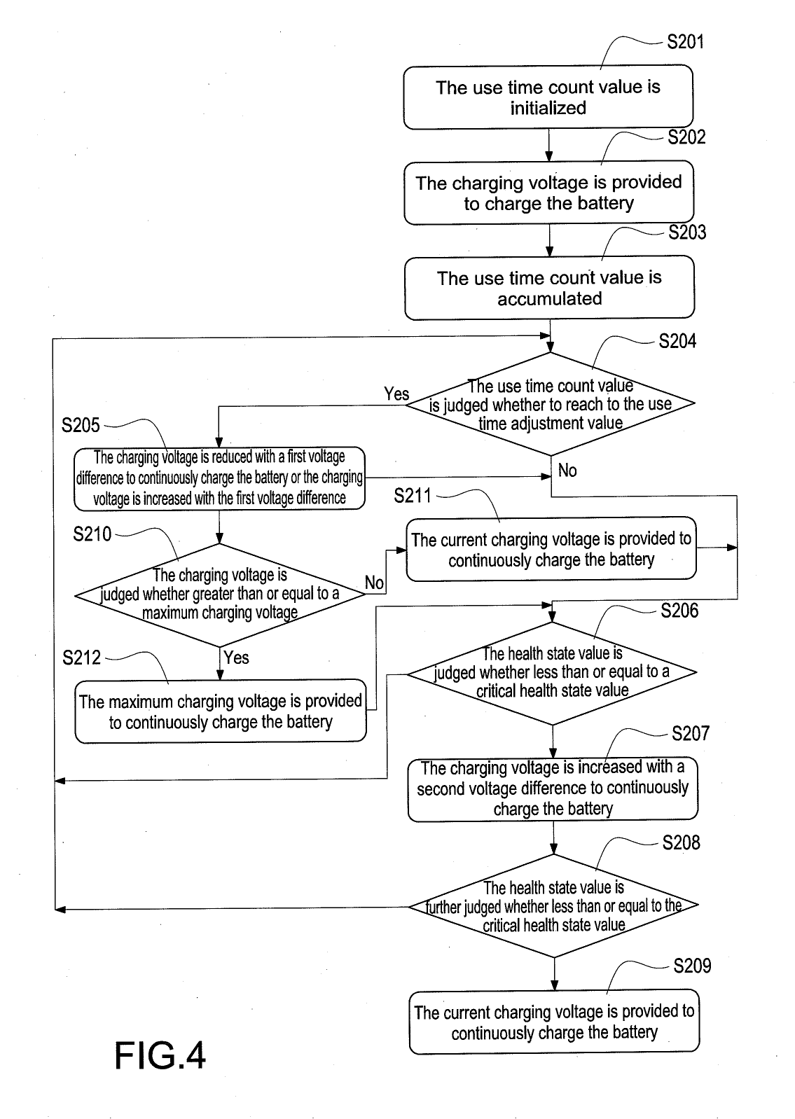

Reference is made to FIG. 4 which is a flowchart of the method according to a second embodiment of the present disclosure. In this embodiment, the use time count value is exemplified for further demonstration. First, the use time count value is initialized (S201). Because the use time count value is used to record the use time after breaking the seal of the battery, the use time count value has to be initialized to zero. Afterward, the charging voltage is provided to charge the battery (S202), that is, the charging process is executed. It is assumed that the charging voltage of the battery is 4.2 volts. Whether the battery is in a charging/discharging operation or an idle condition, the use time count value of the battery is accumulated (S203). Afterward, the use time count value is judged whether to reach to the use time adjustment value (S204). In this embodiment, the charging voltage is adjusted when the use time count value reaches to the use time adjustment value (it is assumed that the use time adjustment value is equal to multiple of two months), thus slowing down decline speed and extending life of the battery. Hence, the step (S204) is that the use time count value is judged whether to reach to multiples of two months. When the use time count value reaches to the use time adjustment value, the charging voltage is reduced with the first voltage difference to continuously charge the battery or the charging voltage is increased with the first voltage difference (S205). Take reducing the charging voltage as the example, it is assumed that the first voltage different is 0.1 volts. That is, the charging voltage is reduced from 4.2 to 4.1 volts when the use time count value reaches to two months, thus slowing down decline speed and extending life of the battery. In addition, in the step (S205), the upper limit of the charging voltage must be limited if the charging voltage is increased for charging the battery. That is, after the step (S205), the charging voltage is judged whether greater than or equal to a maximum charging voltage of the battery (S210). The current charging voltage is provided to continuously charge the battery (S211) when the charging voltage is less than the maximum charging voltage, whereas the maximum charging voltage is provided to continuously charge the battery when the charging voltage is greater than or equal to the maximum charging voltage (S212). Especially, the charging voltage is not limited to be adjusted in only way of reducing or increasing. That is, the charging voltage can be alternatively adjusted between reducing and increasing thereof. On the contrary, in the step (S204), the health state value of the battery is judged whether less than or equal to a critical health state value (S206) when the use time count value does not reach to the use time adjustment value. That is, the current charging voltage is provided to continuously charge the battery when the use time count value does not accumulated to multiples of two months. It is assumed that the critical health state value is set to 80%. Hence, in the step (S206), if the health state value of the battery is greater than 80%, it means that the healthy state of the battery meets product demands so that the step (S203) is executed again. On the contrary, in the step (S206), if the health state value of the battery is less than or equal to 80%, it means that the battery declines below the product demand. Hence, the charging voltage is increased with a second voltage difference to continuously charge the battery (S207). It is assumed that the second voltage difference is 0.1 volts. That is, if the health state value of the battery is less than or equal to 80%, the charging voltage is increased from 4.1 to 4.2 to charge the battery, thus improving performance and extending life of the battery. Afterward, the health state value of the battery is further judged whether less than or equal to the critical health state value (S208). If the health state value of the battery is still less than or equal to 80%, the current charging voltage is provided to charge the battery (S209). That is, if the health state value of the battery still declines below the product demand after increasing the charging voltage, the charging voltage no longer has to be controlled according to these charging control variables. On the contrary, if the health state value of the battery is still greater than the critical health state value, the step (S203) is executed. That is, when the health state value of the battery is greater than 80%, it means that the healthy state of the battery still meets product demands so that the step (S203) is executed again.

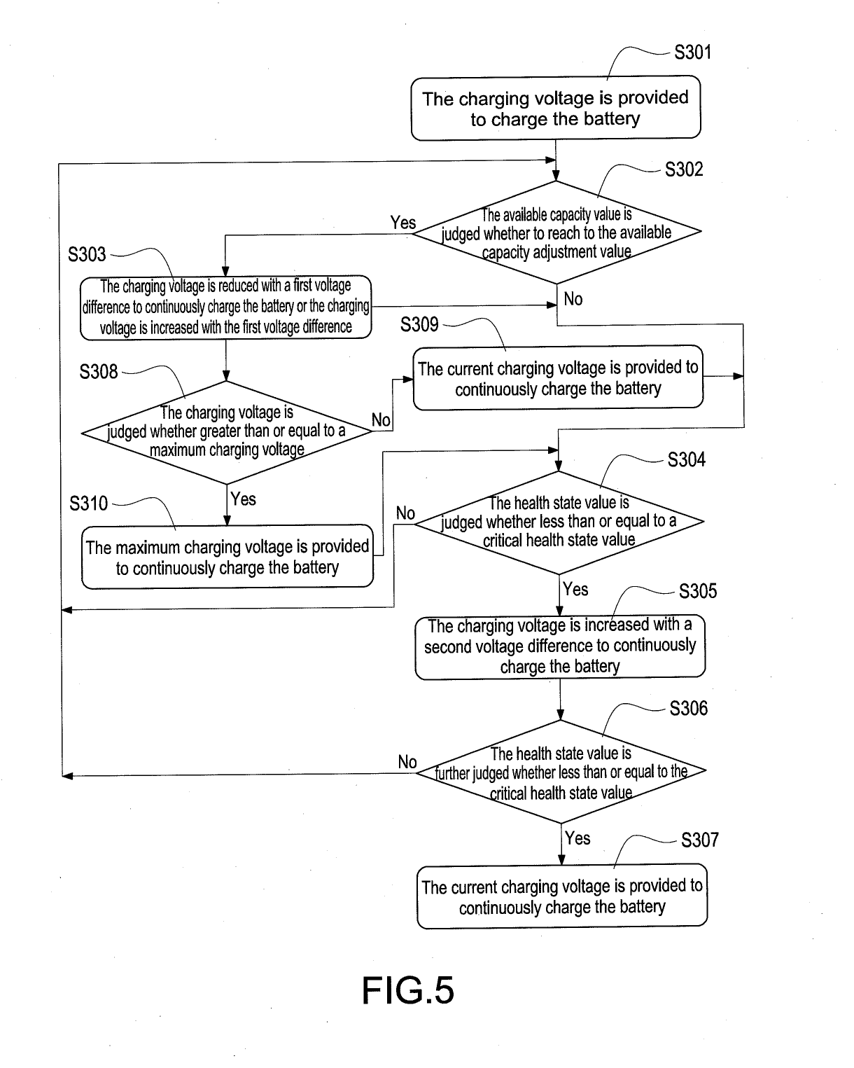

Reference is made to FIG. 5 which is a flowchart of the method according to a third embodiment of the present disclosure. In this embodiment, the available capacity value is exemplified for further demonstration. Because the remaining available capacity of the battery is varied with the use of the battery, the charging voltage is adjusted according to the varied condition. First, the charging voltage is provided to charge the battery (S301), that is, the charging process is executed. It is assumed that the charging voltage of the battery is 4.2 volts. Afterward, the available capacity value is judged whether to reach to the available capacity adjustment value (S302). In this embodiment, the charging voltage is adjusted when the available capacity value of the battery reaches to the available capacity adjustment value (it is assumed that the available capacity adjustment value is equal to every 10% capacity reduction), thus slowing down decline speed and extending life of the battery. Hence, the step (S302) is that the available capacity value is judged whether to reach to every 10% capacity reduction. When the available capacity value reaches to the available capacity adjustment value, the charging voltage is reduced with the first voltage difference to continuously charge the battery or the charging voltage is increased with the first voltage difference (S303). Take reducing the charging voltage as the example, it is assumed that the first voltage different is 0.1 volts. That is, the charging voltage is reduced from 4.2 to 4.1 volts when the available capacity value is reduced from full capacity (100%) to 90% of full capacity, thus slowing down decline speed and extending life of the battery. In addition, in the step (S303), the upper limit of the charging voltage must be limited if the charging voltage is increased for charging the battery. That is, after the step (S303), the charging voltage is judged whether greater than or equal to a maximum charging voltage of the battery (S308). The current charging voltage is provided to continuously charge the battery (S309) when the charging voltage is less than the maximum charging voltage, whereas the maximum charging voltage is provided to continuously charge the battery when the charging voltage is greater than or equal to the maximum charging voltage (S310). Especially, the charging voltage is not limited to be adjusted in only way of reducing or increasing. That is, the charging voltage can be alternatively adjusted between reducing and increasing thereof. On the contrary, in the step (S302), the health state value of the battery is judged whether less than or equal to a critical health state value (S304) when the available capacity value does not reach to the available capacity adjustment value. That is, the current charging voltage is provided to continuously charge the battery when the available capacity value does not reach to every 10% capacity reduction. It is assumed that the critical health state value is set to 80%. Hence, in the step (S304), if the health state value of the battery is greater than 80%, it means that the healthy state of the battery meets product demands so that the step (S302) is executed again. On the contrary, in the step (S304), if the health state value of the battery is less than or equal to 80%, it means that the battery declines below the product demand. Hence, the charging voltage is increased with a second voltage difference to continuously charge the battery (S305). It is assumed that the second voltage difference is 0.1 volts. That is, if the health state value of the battery is less than or equal to 80%, the charging voltage is increased from 4.1 to 4.2 to charge the battery, thus improving performance and extending life of the battery. Afterward, the health state value of the battery is further judged whether less than or equal to the critical health state value (S306). If the health state value of the battery is still less than or equal to 80%, the current charging voltage is provided to charge the battery (S307). That is, if the health state value of the battery still declines below the product demand after increasing the charging voltage, the charging voltage no longer has to be controlled according to these charging control variables. On the contrary, if the health state value of the battery is still greater than the critical health state value, the step (S302) is executed. That is, when the health state value of the battery is greater than 80%, it means that the healthy state of the battery still meets product demands so that the step (S302) is executed again.

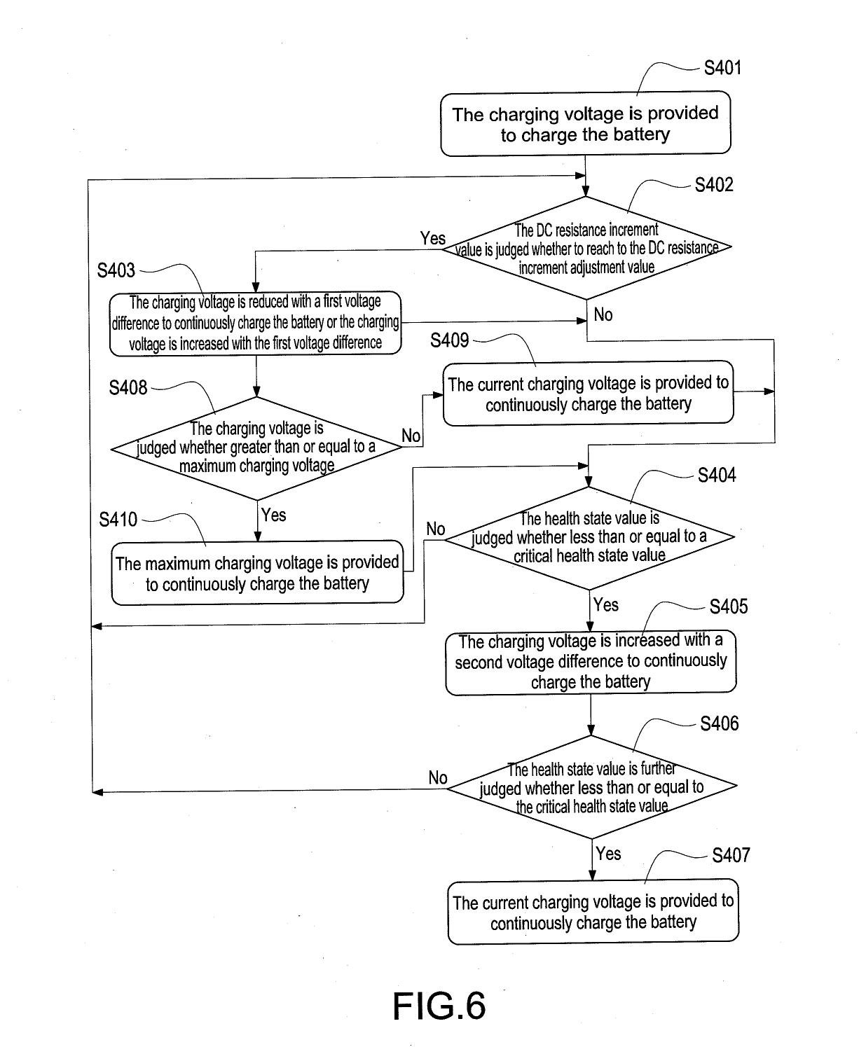

Reference is made to FIG. 6 which is a flowchart of the method according to a fourth embodiment of the present disclosure. In this embodiment, the DC resistance increment value is exemplified for further demonstration. Because the DC resistance increment of the battery is varied with the use of the battery, the charging voltage is adjusted according to the varied condition. First, the charging voltage is provided to charge the battery (S401), that is, the charging process is executed. It is assumed that the charging voltage of the battery is 4.2 volts. Afterward, the DC resistance increment value is judged whether to reach to the DC resistance increment adjustment value (S402). In this embodiment, the charging voltage is adjusted when the DC resistance increment value of the battery reaches to the DC resistance increment adjustment value (it is assumed that the DC resistance increment adjustment value is equal to every 50% resistance increment), thus slowing down decline speed and extending life of the battery. Hence, the step (S402) is that the DC resistance increment value is judged whether to reach to every 50% resistance increment. When the DC resistance increment value reaches to the DC resistance increment adjustment value, the charging voltage is reduced with the first voltage difference to continuously charge the battery or the charging voltage is increased with the first voltage difference (S403). Take reducing the charging voltage as the example, it is assumed that the first voltage different is 0.1 volts. That is, the charging voltage is reduced from 4.2 to 4.1 volts when the DC resistance increment value is increased from initial DC resistance (100%) to 150% of initial DC resistance, thus slowing down decline speed and extending life of the battery. In addition, in the step (S403), the upper limit of the charging voltage must be limited if the charging voltage is increased for charging the battery. That is, after the step (S403), the charging voltage is judged whether greater than or equal to a maximum charging voltage of the battery (S408). The current charging voltage is provided to continuously charge the battery (S409) when the charging voltage is less than the maximum charging voltage, whereas the maximum charging voltage is provided to continuously charge the battery when the charging voltage is greater than or equal to the maximum charging voltage (S410). Especially, the charging voltage is not limited to be adjusted in only way of reducing or increasing. That is, the charging voltage can be alternatively adjusted between reducing and increasing thereof. On the contrary, in the step (S402), the health state value of the battery is judged whether less than or equal to a critical health state value (S404) when the DC resistance increment value does not reach to the DC resistance increment adjustment value. That is, the current charging voltage is provided to continuously charge the battery when the DC resistance increment value does not reach to every 50% resistance increment. It is assumed that the critical health state value is set to 80%. Hence, in the step (S404), if the health state value of the battery is greater than 80%, it means that the healthy state of the battery meets product demands so that the step (S402) is executed again. On the contrary, in the step (S404), if the health state value of the battery is less than or equal to 80%, it means that the battery declines below the product demand. Hence, the charging voltage is increased with a second voltage difference to continuously charge the battery (S405). It is assumed that the second voltage difference is 0.1 volts. That is, if the health state value of the battery is less than or equal to 80%, the charging voltage is increased from 4.1 to 4.2 to charge the battery, thus improving performance and extending life of the battery. Afterward, the health state value of the battery is further judged whether less than or equal to the critical health state value (S406). If the health state value of the battery is still less than or equal to 80%, the current charging voltage is provided to charge the battery (S407). That is, if the health state value of the battery still declines below the product demand after increasing the charging voltage, the charging voltage no longer has to be controlled according to these charging control variables. On the contrary, if the health state value of the battery is still greater than the critical health state value, the step (S402) is executed. That is, when the health state value of the battery is greater than 80%, it means that the healthy state of the battery still meets product demands so that the step (S402) is executed again.

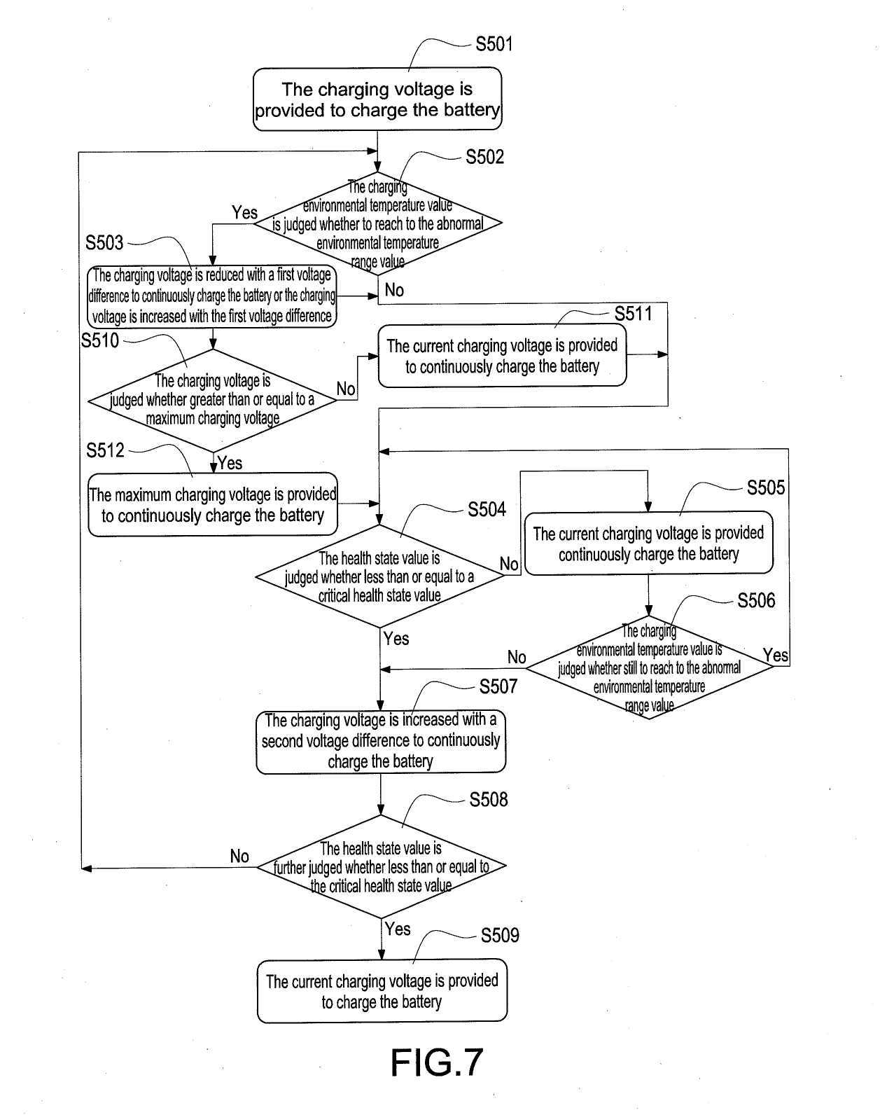

Reference is made to FIG. 7 which is a flowchart of the method according to a fifth embodiment of the present disclosure. In this embodiment, the charging environmental temperature value is exemplified for further demonstration. Because the charging performance of the battery is varied with the current environmental temperature, the charging voltage is adjusted according to the varied condition. First, the charging voltage is provided to charge the battery (S501), that is, the charging process is executed. It is assumed that the charging voltage of the battery is 4.2 volts. Afterward, the charging environmental temperature value is judged whether to reach to the abnormal environmental temperature range value (S502). In this embodiment, the charging voltage is adjusted when the charging environmental temperature value reaches to the abnormal environmental temperature range value (it is assumed that the abnormal environmental temperature range value is outside the range of from 15 to 45° C.), thus slowing down decline speed and extending life of the battery. Hence, the step (S502) is that the charging environmental temperature value is judged whether to reach to outside the range of from 15 to 45° C. When the charging environmental temperature value reaches to the abnormal environmental temperature range value, the charging voltage is reduced with the first voltage difference to continuously charge the battery or the charging voltage is increased with the first voltage difference (S503). Take reducing the charging voltage as the example, it is assumed that the first voltage different is 0.1 volts. That is, the charging voltage is reduced from 4.2 to 4.1 volts when the charging environmental temperature value reaches to outside the range of from 15 to 45° C., thus slowing down decline speed and extending life of the battery. In addition, in the step (S503), the upper limit of the charging voltage must be limited if the charging voltage is increased for charging the battery. That is, after the step (S503), the charging voltage is judged whether greater than or equal to a maximum charging voltage of the battery (S510). The current charging voltage is provided to continuously charge the battery (S511) when the charging voltage is less than the maximum charging voltage, whereas the maximum charging voltage is provided to continuously charge the battery when the charging voltage is greater than or equal to the maximum charging voltage (S512). Especially, the charging voltage is not limited to be adjusted in only way of reducing or increasing. That is, the charging voltage can be alternatively adjusted between reducing and increasing thereof. On the contrary, in the step (S502), the health state value of the battery is judged whether less than or equal to a critical health state value (S504) when the charging environmental temperature value does not reach to the abnormal environmental temperature range value. That is, the current charging voltage is provided to continuously charge the battery when the battery is operated inside the range of from 15 to 45° C. It is assumed that the critical health state value is set to 80%. Hence, in the step (S504), if the health state value of the battery is greater than 80%, it means that the healthy state of the battery meets product demands so that the current charging voltage is provided to continuously charge the battery (S505). In addition, the charging environmental temperature value is judged whether still to reach to the abnormal environmental temperature range value (S506). In the step (S506), the step (S504) is executed, namely, the healthy state of the battery is judged when the charging environmental temperature value still reaches to the abnormal environmental temperature range value. On the contrary, the step (S507) is executed when the charging environmental temperature value reaches to the normal environmental temperature range value, namely, does not reach to the abnormal environmental temperature range value. In particular, the step (S507) will be described hereinafter as follow. In addition, in the step (S504), if the health state value of the battery is less than or equal to 80%, it means that the battery declines below the product demand. Hence, the charging voltage is increased with a second voltage difference to continuously charge the battery (S507). It is assumed that the second voltage difference is 0.1 volts. That is, if the health state value of the battery is less than or equal to 80%, the charging voltage is increased from 4.1 to 4.2 to charge the battery, thus improving performance and extending life of the battery. Afterward, the health state value of the battery is further judged whether less than or equal to the critical health state value (S508). If the health state value of the battery is still less than or equal to 80%, the current charging voltage is provided to charge the battery (S509). That is, if the health state value of the battery still declines below the product demand after increasing the charging voltage, the charging voltage no longer has to be controlled according to these charging control variables. On the contrary, if the health state value of the battery is still greater than the critical health state value, the step (S502) is executed. That is, when the health state value of the battery is greater than 80%, it means that the healthy state of the battery still meets product demands so that the step (S502) is executed again. Especially, the charging control variable can be an average charging environmental temperature value which is calculated during a period of time for another embodiment in the present disclosure. In this embodiment, the period of time is equal to 24 hours, that is the charging voltage is adjusted when the average charging environmental temperature value reaches to the abnormal environmental temperature range value (it is assumed that the abnormal environmental temperature range value is outside the range of from 15 to 45° C.), thus slowing down decline speed and extending life of the battery. The difference between the two embodiments is that the latter embodiment uses the “average” charging environmental temperature as the charging control variable, but the rest is the same. Hence, the detail description is omitted here for conciseness.

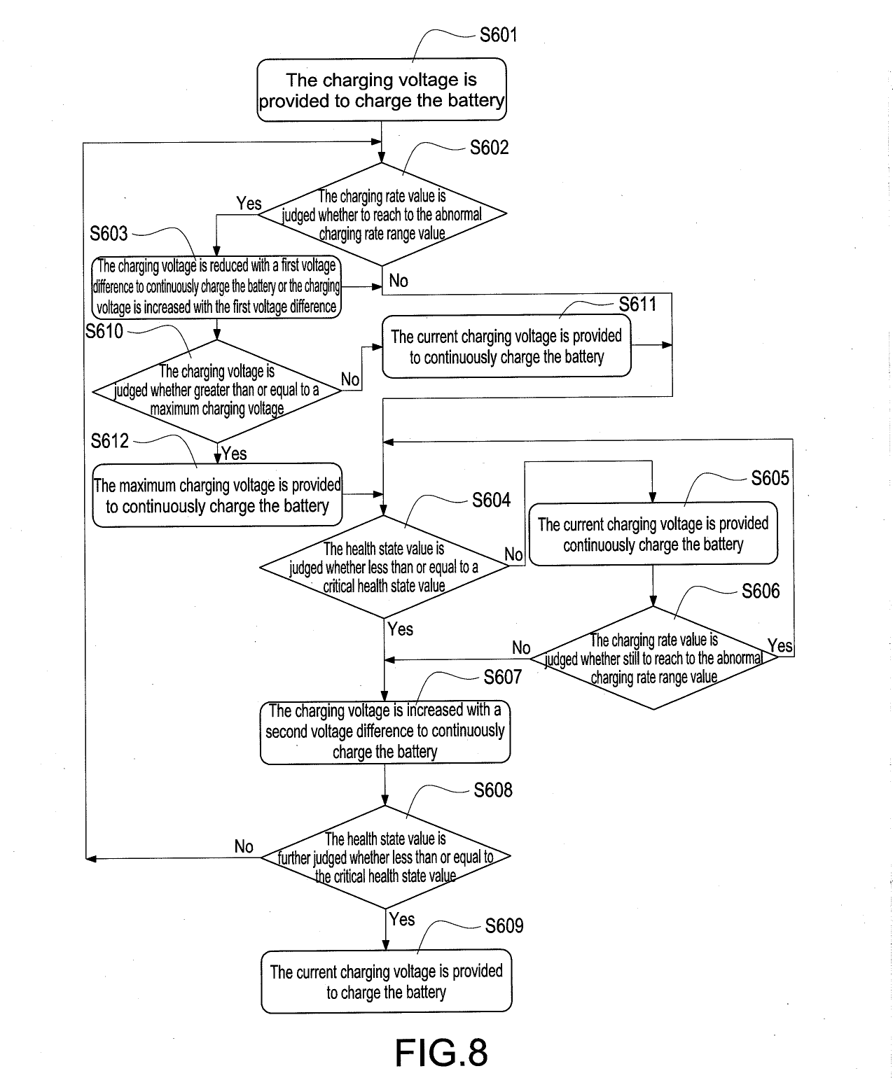

Reference is made to FIG. 8 which is a flowchart of the method according to a sixth embodiment of the present disclosure. In this embodiment, the charging rate value is exemplified for further demonstration. Because the charging condition of the battery is varied with the charging rate of the battery, the charging voltage is adjusted according to the varied condition. First, the charging voltage is provided to charge the battery (S601), that is, the charging process is executed. It is assumed that the charging voltage of the battery is 4.2 volts. Afterward, the charging rate value is judged whether to reach to the abnormal charging rate range value (S602). In this embodiment, the charging voltage is adjusted when the charging rate value reaches to the abnormal charging rate range value (it is assumed that the abnormal charging rate range value is greater than 3.5 amperes), thus slowing down decline speed and extending life of the battery. Hence, the step (S602) is that the charging rate value is judged whether greater than 3.5 amperes. When the charging rate value reaches to the abnormal charging rate range value, the charging voltage is reduced with the first voltage difference to continuously charge the battery or the charging voltage is increased with the first voltage difference (S603). Take reducing the charging voltage as the example, it is assumed that the first voltage different is 0.1 volts. That is, the charging voltage is reduced from 4.2 to 4.1 volts when the charging rate value is greater than 3.5 amperes, thus slowing down decline speed and extending life of the battery. In addition, in the step (S603), the upper limit of the charging voltage must be limited if the charging voltage is increased for charging the battery. That is, after the step (S603), the charging voltage is judged whether greater than or equal to a maximum charging voltage of the battery (S610). The current charging voltage is provided to continuously charge the battery (S611) when the charging voltage is less than the maximum charging voltage, whereas the maximum charging voltage is provided to continuously charge the battery when the charging voltage is greater than or equal to the maximum charging voltage (S612). Especially, the charging voltage is not limited to be adjusted in only way of reducing or increasing. That is, the charging voltage can be alternatively adjusted between reducing and increasing thereof. On the contrary, in the step (S602), the health state value of the battery is judged whether less than or equal to a critical health state value (S604) when the charging rate value does not reach to the abnormal charging rate range value. That is, the current charging voltage is provided to continuously charge the battery when the charging rate value is less than or equal to 3.5 amperes. It is assumed that the critical health state value is set to 80%. Hence, in the step (S604), if the health state value of the battery is greater than 80%, it means that the healthy state of the battery meets product demands so that the current charging voltage is provided to continuously charge the battery (S605). In addition, the charging rate value is judged whether still to reach to the abnormal charging rate range value (S606). In the step (S606), the step (S604) is executed, namely, the healthy state of the battery is judged when the charging rate value still reaches to the abnormal charging rate range value. On the contrary, the step (S607) is executed when the charging rate value reaches to a normal charging rate range value, namely, does not reach to the abnormal charging rate range value. In particular, the step (S607) will be described hereinafter as follow. In addition, in the step (S604), if the health state value of the battery is less than or equal to 80%, it means that the battery declines below the product demand. Hence, the charging voltage is increased with a second voltage difference to continuously charge the battery (S607). It is assumed that the second voltage difference is 0.1 volts. That is, if the health state value of the battery is less than or equal to 80%, the charging voltage is increased from 4.1 to 4.2 to charge the battery, thus improving performance and extending life of the battery. Afterward, the health state value of the battery is further judged whether less than or equal to the critical health state value (S608). If the health state value of the battery is still less than or equal to 80%, the current charging voltage is provided to charge the battery (S609). That is, if the health state value of the battery still declines below the product demand after increasing the charging voltage, the charging voltage no longer has to be controlled according to these charging control variables. On the contrary, if the health state value of the battery is still greater than the critical health state value, the step (S602) is executed. That is, when the health state value of the battery is greater than 80%, it means that the healthy state of the battery still meets product demands so that the step (S602) is executed again.

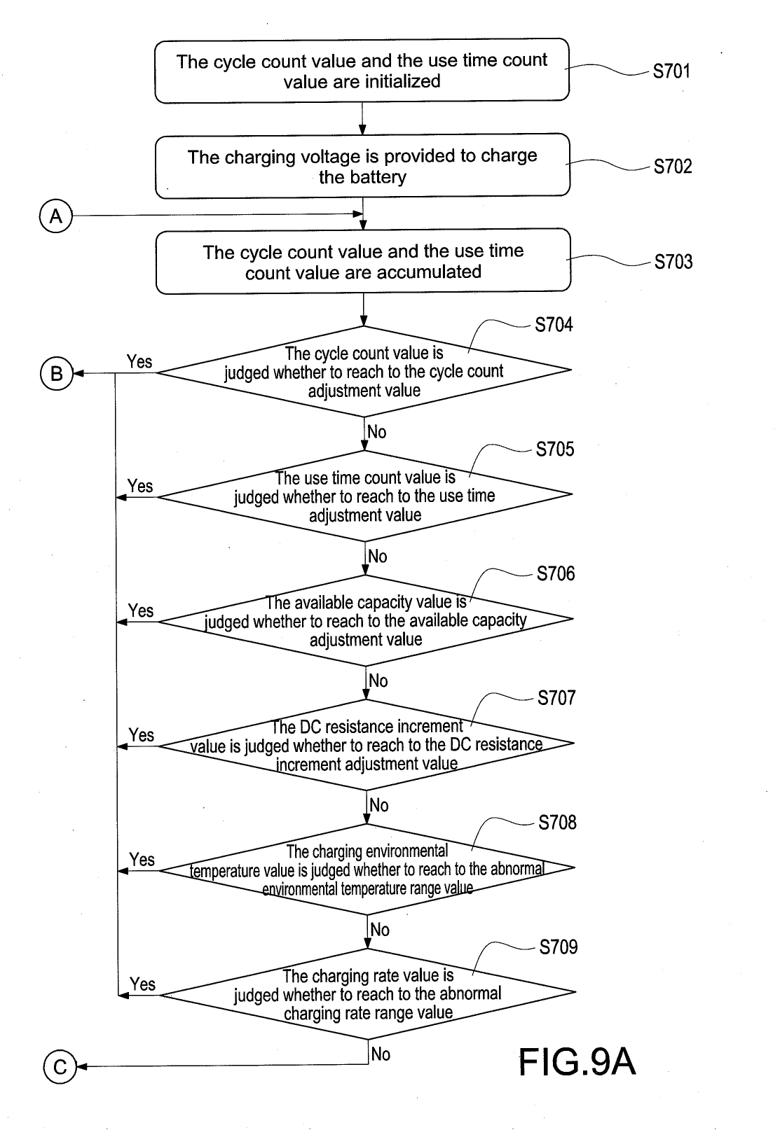

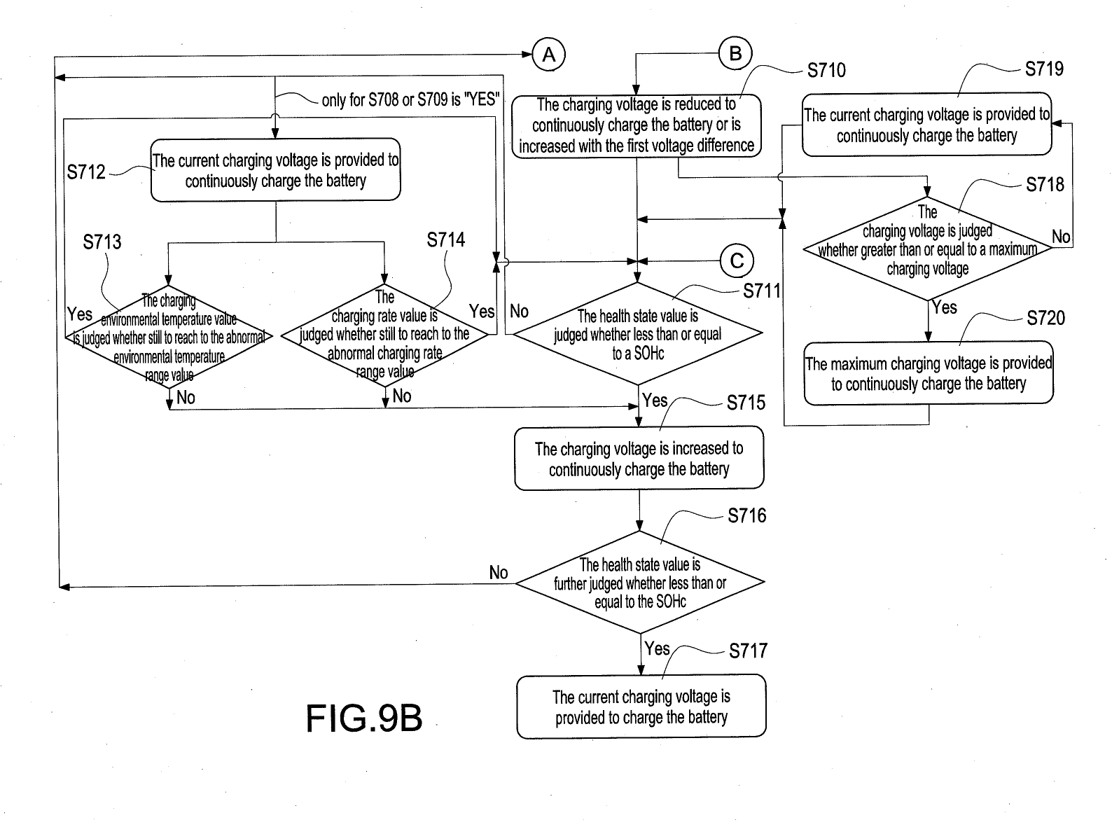

Reference is made to FIG. 9A and FIG. 9B which are flowcharts of the method of combining all charging control variables according to the present disclosure. As mentioned above, the charging control variables are individually described in different embodiments. Especially, it is not limited that only one charging control variable can be used to adjust the charging voltage. Also, the priority of judging the charging control variables is not limited as illustrated in FIG. 9A and FIG. 9B but can be changed based on the actual operation demands. Accordingly, the method of combining the charging control variable can provide more flexible and reliable charging strategies so as to slow down decline speed, improve performance, and extend life of the battery. However, the charging control variables combined and shown in FIG. 9A and FIG. 9B are individually described in the above-mentioned embodiments. Hence, the detail description is omitted here for conciseness.

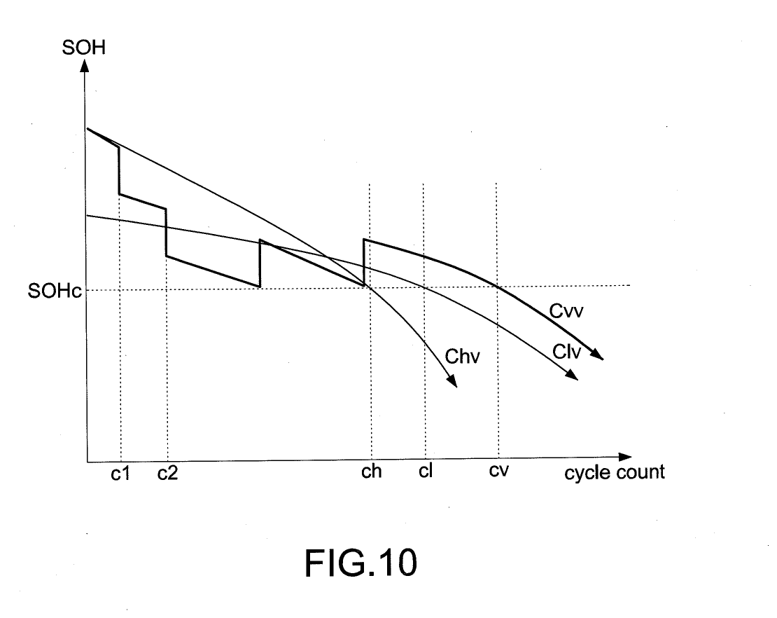

Reference is made to FIG. 10 which is a schematic view of the method of adjusting the charging voltage according to the present disclosure. In this embodiment, the cycle count value is exemplified as the charging control variable to further demonstrate the present disclosure. As shown in FIG. 10, the abscissa represents the cycle count value and the ordinate represents the state of health (SOH) of the battery. A battery life curve Cvv with a variable charging voltage is implemented by adjusting the charging voltage. In addition, the conventional battery life curve Chv with a higher charging voltage and the conventional battery life curve Clv with a lower charging voltage are also illustrated to compare to the battery life curve Cvv. Take reducing the charging voltage as the example, it is assumed that an initial charging voltage is 4.2 volts, a cycle count adjustment value is set to multiples of 100, a critical health state value SOHc is set to 80%, and a first voltage difference and a second voltage difference are both set to 0.1 volts. First, the cycle count value is initialized. When the cycle count value reaches to a first cycle count adjustment value C1 (C1=100) and the state of health of the battery is greater than the critical health state value SOHc, the charging voltage is reduced from 4.2 to 4.1 volts. Afterward, when the cycle count value reaches to a second cycle count adjustment value C2 (C2=200) and the state of heath of the battery is still greater than the critical health state value SOHc, the charging voltage is reduce from 4.1 to 4.0 volts, thus slowing down cline speed and extending life of the battery. That is, before the cycle count value reaches to the first cycle count adjustment C1, the battery is continuously charged with 4.2 volts; when the cycle count value is between the first cycle count adjustment value C1 and the second cycle count adjustment value C2, the battery is continuously charged with 4.1 volts. Until the state of health of the battery is less than or equal to the critical health state value SOHc, the charging voltage is increased from 4.0 to 4.1 volts. Similarly, when the state of health of the battery is less than or equal to the critical health state value SOHc again, the charging voltage is increased from 4.1 to 4.2 volts, thus improving performance of the battery. However, if the state of heath of the battery still declines below the product demand (namely, is less than or equal to the critical health state value SOHc) after increasing the charging voltage, the charging voltage no longer has to be controlled according to cycle count value. Comparing with the conventional constant voltage charging method, it is obvious that the number of times of the cycle count of the battery life curve Chv above the critical health state value SOHc is ch and that of the cycle count of the battery life curve Clv is cl, whereas that of the cycle count of the battery life curve Cvv is cv. In particular, the relationship between the three numbers is cv>cl>ch. Accordingly, the method can provide more flexible and reliable charging strategies so as to slow down decline speed, improve performance, and extend life of the battery.

In conclusion, the present disclosure has following advantages:

1. The charging voltage can be adjusted according to the different charging control variables (including the cycle count value, the use time count value, the available capacity value, the DC resistance increment value, the charging environmental temperature value, and the charging rate value) and the health state value of the battery so as to slow down decline speed, improve performance, and extend life of the battery;

2. Different combinations of the charging control variables can be implemented to provide more flexible and reliable charging strategies; and

3. The charging voltage can be adjusted in the way of reducing or increasing, also can be alternatively adjusted between reducing and increasing thereof, thus providing more flexible charging control to slow down decline speed and improve performance of the battery.

Although the present disclosure has been described with reference to the preferred embodiment thereof, it will be understood that the present disclosure is not limited to the details thereof. Various substitutions and modifications have been suggested in the foregoing description, and others will occur to those of ordinary skill in the art. Therefore, all such substitutions and modifications are intended to be embraced within the scope of the present disclosure as defined in the appended claims.

What is claimed is:

1. A method of charging a battery comprising following steps:
(a) providing a charging voltage to charge the battery;
(b) judging whether a charging control variable reaches to an adjustment value;
(c) adjusting the charging voltage with a first voltage difference to continuously charge the battery when the charging control variable reaches to the adjustment value;
(d) judging whether a health state value of the battery is less than or equal to a critical health state value; and
(e) increasing the charging voltage with a second voltage difference to continuously charge the battery when the health state value of the battery is less than or equal to the critical health state value.

2. The method of charging the battery in claim 1, wherein after the step (b), further comprising (c2) executing the step (d) when the charging control variable does not reach to the adjustment value; and after the step (d), further comprising (e2) executing the step (b) when the health state value of the battery is greater than the critical health state value.

3. The method of charging the battery in claim 1, wherein after the step (e), further comprising (f) judging whether the health state value of the battery is less than or equal to the critical health state value; and (g) executing the step (b) when the health state value of the battery is greater than the critical health state value; (g2) continuously charging the battery when the health state value of the battery is less than or equal to the critical health state value.

4. The method of charging the battery in claim 1, wherein when the charging control variable is a cycle count value and the adjustment value is a cycle count adjustment value, before the step (a), further comprising (a0) initializing the cycle count value; in the step (b), judging whether the cycle count value reaches to the cycle count adjustment value; in the step (c), reducing the charging voltage with a first voltage difference to continuously charge the battery when the cycle count value reaches to the cycle count adjustment value.

5. The method of charging the battery in claim 1, wherein when the charging control variable is a use time count value and the adjustment value is a use time adjustment value, before the step (a), further comprising (a0) initializing the use time count value; in the step (b), judging whether the use time count value reaches to the use time adjustment value; in the step (c), reducing the charging voltage with a first voltage difference to continuously charge the battery when the use time count value reaches to the use time adjustment value.

6. The method of charging the battery in claim 1, wherein when the charging control variable is an available capacity value and the adjustment value is an available capacity adjustment value, in the step (b), judging whether the available capacity value reaches to the available capacity adjustment value; in the step (c), reducing the charging voltage with a first voltage difference to continuously charge the battery when the available capacity value reaches to the available capacity adjustment value.

7. The method of charging the battery in claim 1, wherein when the charging control variable is a DC resistance increment value and the adjustment value is a DC resistance increment adjustment value, in the step (b), judging whether the DC resistance increment value reaches to the DC resistance increment adjustment value; in the step (c), reducing the charging voltage with a first voltage difference to continuously charge the battery when the DC resistance increment value reaches to the DC resistance increment adjustment value.

8. The method of charging the battery in claim 1, wherein when the charging control variable is a charging environmental temperature value and the adjustment value is an abnormal environmental temperature range value, in the step (b), judging whether the charging environmental temperature value reaches to the abnormal environmental temperature range value; in the step (c), reducing the charging voltage with a first voltage difference to continuously charge the battery when the charging environmental temperature value reaches to the abnormal environmental temperature range value.

9. The method of charging the battery in claim 1, wherein when the charging control variable is a charging rate value and the adjustment value is an abnormal charging rate range value, in the step (b), judging whether the charging rate value reaches to the abnormal charging rate range value; in the step (c), reducing the charging voltage with a first voltage difference to continuously charge the battery when the charging rate value reaches to the abnormal charging rate range value.

10. The method of charging the battery in claim 1, wherein the charging control variable is a cycle count value, a use time count value, an available capacity value, a DC resistance increment value, a charging environmental temperature value, a charging rate value, or any combination of any two or more thereof.

11. The method of charging the battery in claim 10, wherein when the charging control variable is the cycle count value and the adjustment value is a cycle count adjustment value, before the step (a), further comprising (a0) initializing the cycle count value; in the step (b), judging whether the cycle count value reaches to the cycle count adjustment value; in the step (c), reducing the charging voltage with a first voltage difference to continuously charge the battery when the cycle count value reaches to the cycle count adjustment value; wherein when the charging control variable is a use time count value and the adjustment value is a use time adjustment value, before the step (a), further comprising (a0) initializing the use time count value; in the step (b), judging whether the use time count value reaches to the use time adjustment value; in the step (c), reducing the charging voltage with a first voltage difference to continuously charge the battery when the use time count value reaches to the use time adjustment value; wherein when the charging control variable is an available capacity value and the adjustment value is an available capacity adjustment value, in the step (b), judging whether the available capacity value reaches to the available capacity adjustment value; in the step (c), reducing the charging voltage with a first voltage difference to continuously charge the battery when the available capacity value reaches to the available capacity adjustment value; wherein when the charging control variable is a DC resistance increment value and the adjustment value is a DC resistance increment adjustment value, in the step (b), judging whether the DC resistance increment value reaches to the DC resistance increment adjustment value; in the step (c), reducing the charging voltage with a first voltage difference to continuously charge the battery when the DC resistance increment value reaches to the DC resistance increment adjustment value; wherein when the charging control variable is a charging environmental temperature value and the adjustment value is an abnormal environmental temperature range value, in the step (b), judging whether the charging environmental temperature value reaches to the abnormal environmental temperature range value; in the step (c), reducing the charging voltage with a first voltage difference to continuously charge the battery when the charging environmental temperature value reaches to the abnormal environmental temperature range value; wherein when the charging control variable is a charging rate value and the adjustment value is an abnormal charging rate range value, in the step (b), judging whether the charging rate value reaches to the abnormal charging rate range value; in the step (c), reducing the charging voltage with a first voltage difference to continuously charge the battery when the charging rate value reaches to the abnormal charging rate range value.

12. The method of charging the battery in claim 1, wherein when the charging control variable is a cycle count value and the adjustment value is a cycle count adjustment value, before the step (a), further comprising (a0) initializing the cycle count value; in the step (b), judging whether the cycle count value reaches to the cycle count adjustment value; in the step (c), increasing the charging voltage with a first voltage difference when the cycle count value reaches to the cycle count adjustment value; after the step (c), further comprising judging whether the charging voltage is greater than or equal to a maximum charging voltage; the charging voltage is provided to continuously charge the battery when the charging voltage is less than the maximum charging voltage; the maximum charging voltage is provided to continuously charge the battery when the charging voltage is greater than or equal to the maximum charging voltage.

13. The method of charging the battery in claim 1, wherein when the charging control variable is a use time count value and the adjustment value is a use time adjustment value, before the step (a), further comprising (a0) initializing the use time count value; in the step (b), judging whether the use time count value reaches to the use time adjustment value; in the step (c), increasing the charging voltage with a first voltage difference when the use time count value reaches to the use time adjustment value; after the step (c), further comprising judging whether the charging voltage is greater than or equal to a maximum charging voltage; the charging voltage is provided to continuously charge the battery when the charging voltage is less than the maximum charging voltage; the maximum charging voltage is provided to continuously charge the battery when the charging voltage is greater than or equal to the maximum charging voltage.

14. The method of charging the battery in claim 1, wherein when the charging control variable is an available capacity value and the adjustment value is an available capacity adjustment value, in the step (b), judging whether the available capacity value reaches to the available capacity adjustment value; in the step (c), increasing the charging voltage with a first voltage difference when the available capacity value reaches to the available capacity adjustment value; after the step (c), further comprising judging whether the charging voltage is greater than or equal to a maximum charging voltage; the charging voltage is provided to continuously charge the battery when the charging voltage is less than the maximum charging voltage; the maximum charging voltage is provided to continuously charge the battery when the charging voltage is greater than or equal to the maximum charging voltage.

15. The method of charging the battery in claim 1, wherein when the charging control variable is a DC resistance increment value and the adjustment value is a DC resistance increment adjustment value, in the step (b), judging whether the DC resistance increment value reaches to the DC resistance increment adjustment value; in the step (c), increasing the charging voltage with a first voltage difference when the DC resistance increment value reaches to the DC resistance increment adjustment value; after the step (c), further comprising judging whether the charging voltage is greater than or equal to a maximum charging voltage; the charging voltage is provided to continuously charge the battery when the charging voltage is less than the maximum charging voltage; the maximum charging voltage is provided to continuously charge the battery when the charging voltage is greater than or equal to the maximum charging voltage.

16. The method of charging the battery in claim 1, wherein when the charging control variable is a charging environmental temperature value and the adjustment value is an abnormal environmental temperature range value, in the step (b), judging whether the charging environmental temperature value reaches to the abnormal environmental temperature range value; in the step (c), increasing the charging voltage with a first voltage difference when the charging environmental temperature value reaches to the abnormal environmental temperature range value; after the step (c), further comprising judging whether the charging voltage is greater than or equal to a maximum charging voltage; the charging voltage is provided to continuously charge the battery when the charging voltage is less than the maximum charging voltage; the maximum charging voltage is provided to continuously charge the battery when the charging voltage is greater than or equal to the maximum charging voltage.

17. The method of charging the battery in claim 1, wherein when the charging control variable is a charging rate value and the adjustment value is an abnormal charging rate range value, in the step (b), judging whether the charging rate value reaches to the abnormal charging rate range value; in the step (c), increasing the charging voltage with a first voltage difference when the charging rate value reaches to the abnormal charging rate range value; after the step (c), further comprising judging whether the charging voltage is greater than or equal to a maximum charging voltage; the charging voltage is provided to continuously charge the battery when the charging voltage is less than the maximum charging voltage; the maximum charging voltage is provided to continuously charge the battery when the charging voltage is greater than or equal to the maximum charging voltage.

18. The method of charging the battery in claim 10, wherein when the charging control variable is a cycle count value and the adjustment value is a cycle count adjustment value, before the step (a), further comprising (a0) initializing the cycle count value; in the step (b), judging whether the cycle count value reaches to the cycle count adjustment value; in the step (c), increasing the charging voltage with a first voltage difference when the cycle count value reaches to the cycle count adjustment value; after the step (c), further comprising judging whether the charging voltage is greater than or equal to a maximum charging voltage; the charging voltage is provided to continuously charge the battery when the charging voltage is less than the maximum charging voltage; the maximum charging voltage is provided to continuously charge the battery when the charging voltage is greater than or equal to the maximum charging voltage; wherein when the charging control variable is a use time count value and the adjustment value is a use time adjustment value, before the step (a), further comprising (a0) initializing the use time count value; in the step (b), judging whether the use time count value reaches to the use time adjustment value; in the step (c), increasing the charging voltage with a first voltage difference when the use time count value reaches to the use time adjustment value; after the step (c), further comprising judging whether the charging voltage is greater than or equal to a maximum charging voltage; the charging voltage is provided to continuously charge the battery when the charging voltage is less than the maximum charging voltage; the maximum charging voltage is provided to continuously charge the battery when the charging voltage is greater than or equal to the maximum charging voltage; wherein when the charging control variable is an available capacity value and the adjustment value is an available capacity adjustment value, in the step (b), judging whether the available capacity value reaches to the available capacity adjustment value; in the step (c), increasing the charging voltage with a first voltage difference when the available capacity value reaches to the available capacity adjustment value; after the step (c), further comprising judging whether the charging voltage is greater than or equal to a maximum charging voltage; the charging voltage is provided to continuously charge the battery when the charging voltage is less than the maximum charging voltage; the maximum charging voltage is provided to continuously charge the battery when the charging voltage is greater than or equal to the maximum charging voltage; wherein when the charging control variable is a DC resistance increment value and the adjustment value is a DC resistance increment adjustment value, in the step (b), judging whether the DC resistance increment value reaches to the DC resistance increment adjustment value; in the step (c), increasing the charging voltage with a first voltage difference when the DC resistance increment value reaches to the DC resistance increment adjustment value; after the step (c), further comprising judging whether the charging voltage is greater than or equal to a maximum charging voltage; the charging voltage is provided to continuously charge the battery when the charging voltage is less than the maximum charging voltage; the maximum charging voltage is provided to continuously charge the battery when the charging voltage is greater than or equal to the maximum charging voltage; wherein when the charging control variable is a charging environmental temperature value and the adjustment value is an abnormal environmental temperature range value, in the step (b), judging whether the charging environmental temperature value reaches to the abnormal environmental temperature range value; in the step (c), increasing the charging voltage with a first voltage difference when the charging environmental temperature value reaches to the abnormal environmental temperature range value; after the step (c), further comprising judging whether the charging voltage is greater than or equal to a maximum charging voltage; the charging voltage is provided to continuously charge the battery when the charging voltage is less than the maximum charging voltage; the maximum charging voltage is provided to continuously charge the battery when the charging voltage is greater than or equal to the maximum charging voltage; wherein when the charging control variable is a charging rate value and the adjustment value is an abnormal charging rate range value, in the step (b), judging whether the charging rate value reaches to the abnormal charging rate range value; in the step (c), increasing the charging voltage with a first voltage difference when the charging rate value reaches to the abnormal charging rate range value; after the step (c), further comprising judging whether the charging voltage is greater than or equal to a maximum charging voltage; the charging voltage is provided to continuously charge the battery when the charging voltage is less than the maximum charging voltage; the maximum charging voltage is provided to continuously charge the battery when the charging voltage is greater than or equal to the maximum charging voltage.
